(19) United States
(12) Patent Application Publication
(10) Pub. No.: US 2026/0163900 A1
(43) Pub. Date: Jun. 11, 2026

(54) METHOD AND SYSTEM FOR COLLECTING AND PROCESSING OFFENSIVE AND DEFENSIVE ELEMENTS BASED ON MULTI-SOURCE DATA

(71) Applicant: Huaneng Information Technology Co., Ltd., Qingdao (CN)

(72) Inventors: Ziqiang Wen, Qingdao (CN); Shuo Han, Qingdao (CN); Sheng Ye, Qingdao (CN); Hao Guo, Qingdao (CN); Yujie Liu, Qingdao (CN); Mengdi Zhu, Qingdao (CN); Jiyao Sun, Qingdao (CN); Tao Sun, Qingdao (CN); Chengfeng Song, Qingdao (CN); Qiang Zhang, Qingdao (CN)

(73) Assignee: Huaneng Information Technology Co., Ltd., Qingdao (CN)

(21) Appl. No.: 19/281,525

(22) Filed: Jul. 25, 2025

(30) Foreign Application Priority Data
Jul. 1, 2025 (CN) 202510905228.3

(51) Int. Cl. H04L 9/40

(52) U.S. Cl. CPC H04L 63/1425

(57) ABSTRACT

The disclosure relates to a method and a system for collecting and processing offensive and defensive elements based on multi-source data. The method includes: constructing multiple data monitoring points based on network system parameters; generating a collection evaluation value of each of the data monitoring points, and setting an initial collection frequency of each of the data monitoring points according to all collection evaluation values; obtaining a monitoring data packet of each of the data monitoring points, and determining whether to generate a first-level collection instruction of each of the monitoring points according to all monitoring data packets. Multiple data monitoring points are established in the network system according to the characteristics of offensive and defensive elements, and the preprocessing model and initial collection frequency of each data monitoring point are dynamically adjusted according to the historical characteristics of each data monitoring point, thereby reducing the overall operating load.

### CROSS-REFERENCE TO RELATED APPLICATIONS

This application claims priority of Chinese Patent Application No. 202510905228.3, filed on Jul. 1, 2025, the contents of which are hereby incorporated by reference.

### TECHNICAL FIELD

The disclosure relates to the technical field of network offensive and defense elements, and in particular to a method and a system for collecting and processing offensive and defensive elements based on multi-source data.

### BACKGROUND

With the increasing complexity of network attack means and the frequent appearance of advanced persistent threats, it is urgent for the network security defense system to shift from passive response to active prediction and collaborative protection. The dynamic collection and efficient processing of offensive and defensive elements (such as attack characteristics, vulnerability information, threat intelligence, defense strategy, etc.) has become the core foundation for building intelligent security defense capabilities.

The prior art mostly relies on a single data source, such as a log system, a single-point honeypot or an open vulnerability database, and lacks the collaborative collection ability of multi-dimensional heterogeneous data such as dark forum, open source intelligence, terminal behavior data and cloud platform traffic, which leads to a blind spot in threat perception. The elements of each link in the attack chain are not effectively related, which makes it difficult for fragmented information to form a systematic knowledge map that may guide active defense.

### SUMMARY

The purpose of this disclosure is to solve the above technical problems, and the disclosure provides a method and a system for collecting and processing offensive and defensive elements based on multi-source data, aiming at improving the collection efficiency of offensive and defensive element data and improving the overall linkage analysis efficiency of attack chains.

In some embodiments of the disclosure, multiple data monitoring points are built in the network system according to the characteristics of offensive and defensive elements, and the preprocessing model and initial collection frequency of each data monitoring point are dynamically adjusted according to the historical characteristics of each data monitoring point, thereby reducing the overall operating load. The efficiency of collecting and analyzing the offensive and defensive elements of the network system is improved.

In some embodiments of the disclosure, by building a multi-level early warning strategy for each of the data monitoring points, the fluctuation state of the offensive and defensive elements of each data monitoring point is warned in time, and the collection efficiency of the offensive and defensive elements is improved. At the same time, by constructing a collection model, the collection strategy of the correlated monitoring point is adjusted in time when the target monitoring point collects data, so as to realize the collaborative collection of multi-dimensional heterogeneous data and improve the collection and analysis efficiency of the offensive and defensive elements of the network system.

In some embodiments of the disclosure, a method for collecting and processing offensive and defensive elements based on multi-source data is provided, including:
constructing multiple data monitoring points based on network system parameters;
generating a collection evaluation value of each of the data monitoring points, and setting an initial collection frequency of each of the data monitoring points according to all collection evaluation values; and
obtaining a monitoring data packet of each of the data monitoring points, and determining whether to generate a first-level collection instruction of each of the monitoring points according to all monitoring data packets;
where constructing multiple data monitoring points includes:
building a data monitoring point sequence A, and A=(a₁, a₂ . . . aᵢ . . . aₙ), where aᵢ is an i-th data monitoring point; n is a number of the data monitoring points.

In some embodiments of the disclosure, generating a collection evaluation value of each of the data monitoring points includes:
sequentially setting aᵢ as a monitoring point to be evaluated according to the data monitoring point sequence A;
generating a correlated value between the monitoring point to be evaluated and each of the data monitoring points based on a preset correlation model;
building a correlated monitoring point sequence P of the monitoring point to be evaluated based on all correlated values, and P=(p₁, p₂ . . . pᵢ . . . pₙ₁), where n₁ is a number of correlated monitoring points of the monitoring point to be evaluated; pᵢ is an i-th correlated monitoring point of the monitoring point to be evaluated;
obtaining a historical data packet of the monitoring point to be evaluated;
generating a collection evaluation value b of the monitoring point to be evaluated according to the correlated monitoring point sequence P and the historical data packet;
sequentially generating the collection evaluation value of each of the data monitoring points; and
building a collection evaluation value sequence B, and B=(b₁, b₂ . . . bᵢ . . . bₙ), where bᵢ is a collection evaluation value of an i-th data monitoring point.

In some embodiments of the disclosure, generating a collection evaluation value b of the monitoring point to be evaluated includes:

$$b = e 1 * Q 1 * [ {\sum }_{i = 1}^{θ 1} {β}_{i} * {v}_{i} ] + e 2 * θ 2 * [ {\sum }_{i = 1}^{n 1} {η}_{i} * {s}_{i} ] ;$$

where, e1 is a preset first weight coefficient; e2 is a preset second weight coefficient; Q1 is a preset first fixed coefficient; Q2 is a preset second fixed coefficient; θ1 is a number of historical evaluation indicators; βᵢ is an influence factor of an i-th historical evaluation indicator; vᵢ is a reference value of the i-th historical evaluation indicator generated based on the historical data packet; n1 is a number of correlated monitoring points of the monitoring point to be evaluated; ηᵢ is an influence factor of an i-th correlated monitoring point of the monitoring point to be evaluated; sᵢ is an auxiliary evaluation value of the i-th correlated monitoring point of the monitoring point to be evaluated.

In some embodiments of the disclosure, obtaining a monitoring data packet of each of the data monitoring points includes:
sequentially setting aᵢ as a target monitoring point according to the data monitoring point sequence A;
building a collection time axis of the target monitoring point according to an initial collection frequency of the target monitoring point, where the collection time axis includes multiple collection time nodes;
building a preprocessing model of the target monitoring point;
obtaining original data of the target monitoring point at a current collection time node;
generating a current monitoring data packet of the target monitoring point according to the preprocessing model and the original data;
generating an abnormal risk value c of the target monitoring point according to the monitoring data packet;
determining whether to generate a first-level collection instruction of the target monitoring point according to the abnormal risk value c; and
sequentially determining whether each of the data monitoring points generates the first-level collection instruction.

In some embodiments of the disclosure, generating an abnormal risk value c of the target monitoring point includes:
generating an initial abnormal value d1 of the target monitoring point based on the monitoring data packet;

$$d 1 = [ {\sum }_{i = 1}^{θ 2} {μ}_{i} * {j}_{i} ] ;$$

where, θ2 is a number of characteristic indicators of the target monitoring point; μᵢ is an influence factor of an i-th characteristic indicator; jᵢ is a matching value of the i-th characteristic indicator generated based on the monitoring data packet;
presetting an initial abnormal value threshold D;
if d1>D, setting the abnormal risk value c of the target monitoring point as the initial abnormal value d1, that is, c=d1;
if d1<D, generating a second-level abnormal value d2; and
generating the abnormal risk value c according to the initial abnormal value d1 and the second-level abnormal value d2, where c=e3*d1+e4*d2;
where e3 is a preset third weight coefficient; e4 is a preset fourth weight coefficient.

In some embodiments of the disclosure, generating a second-level abnormal value d2 includes:

$$d 2 = [ {\sum }_{i = 1}^{θ 3} {λ}_{i} * {( {w}_{i} - {w}_{i}^{′} )}^{2} ] ;$$

where, θ3 is a number of abnormal indicators of the target monitoring point; λᵢ is an influence factor of an i-th abnormal indicator of the target monitoring point; wᵢ is a real-time reference value of the i-th abnormal indicator of the target monitoring point; w′ᵢ is a standard reference value of the i-th abnormal indicator of the target monitoring point.

In some embodiments of the disclosure, determining whether to generate the first-level collection instruction of the target monitoring point according to the abnormal risk value c includes:
pre-processing an abnormal risk value threshold C1;
if c<C1, the target monitoring point fails to generate the first-level collection instruction; and
if c>C1, the target monitoring point generates the first-level collection instruction.

In some embodiments of the disclosure, the first-level collection instruction includes:
setting a first-level collection strategy of the target monitoring point according to the abnormal risk value c, and obtaining a first-level feedback data packet of the target monitoring point according to the first-level collection strategy;
building a correlated monitoring point sequence A2 of the target monitoring point, and A2=(a₂₁, a₂₂ . . . a₂ᵢ . . . a₂ₙ₂), where a₂ᵢ is a number of i-th correlated monitoring points of the target monitoring point; n2 is a number of correlated monitoring points of the target monitoring point;
setting an auxiliary collection strategy of each of the correlated monitoring points;
obtaining a second-level feedback data packet of each of the correlated monitoring points according to all auxiliary collection strategies;
determining whether to generate an early warning instruction of each of the correlated monitoring points according to the second-level feedback data packet; and
generating a data packet to be analyzed at the target monitoring point according to the first-level feedback data packet and all second-level feedback data packets.

In some embodiments of the disclosure, a system for collecting and processing offensive and defensive elements based on multi-source data is provided, and includes:
a central control module, configured for constructing multiple data monitoring points based on network system parameters;
a first processing module, configured for generating a collection evaluation value of each of the data monitoring points;
a second processing module, configured for setting an initial collection frequency of each of the data monitoring points according to all collection evaluation values; and
a third processing module, configured for obtaining a monitoring data packet of each of the data monitoring points and determining whether to generate a first-level collection instruction of each of the monitoring points according to all monitoring data packets;
where the central control module is further configured for building a data monitoring point sequence A, and A=(a₁, a₂ . . . aᵢ . . . aₙ), where aᵢ is an i-th data monitoring point; n is a number of the data monitoring points.

In some embodiments of the disclosure, the first processing module is further configured for:
sequentially setting aᵢ as a monitoring point to be evaluated according to the data monitoring point sequence A;
generating a correlated value between the monitoring point to be evaluated and each of the data monitoring points based on a preset correlation model;
building a correlated monitoring point sequence P of the monitoring point to be evaluated based on all correlated values, and P=(p₁, p₂ . . . pᵢ . . . pₙ₁), where n1 is a number of correlated monitoring points of the monitoring point to be evaluated; pᵢ is an i-th correlated monitoring point of the monitoring point to be evaluated;
obtaining a historical data packet of the monitoring point to be evaluated;
generating a collection evaluation value b of the monitoring point to be evaluated according to the correlated monitoring point sequence P and the historical data packet;
sequentially generating the collection evaluation value of each of the data monitoring points; and
building a collection evaluation value sequence B, and B=(b₁, b₂ . . . bᵢ . . . bₙ), where bᵢ is a collection evaluation value of an i-th data monitoring point.

Compared with the prior art, the method and the system for collecting and processing offensive and defensive elements based on multi-source data in the embodiment of the disclosure have the following beneficial effects.

Multiple data monitoring points are established in the network system according to the characteristics of offensive and defensive elements, and the preprocessing model and initial collection frequency of each data monitoring point are dynamically adjusted according to the historical characteristics of each data monitoring point, thereby reducing the overall operating load. The efficiency of collecting and analyzing the offensive and defensive elements of the network system is improved

By building a multi-level early warning strategy for each of the data monitoring points, the fluctuation state of the offensive and defensive elements of each data monitoring point is warned in time, and the collection efficiency of the offensive and defensive elements is improved. At the same time, by constructing a collection model, the collection strategy of the correlated monitoring point is adjusted in time when the target monitoring point collects data, so as to realize the collaborative collection of multi-dimensional heterogeneous data and improve the collection and analysis efficiency of the offensive and defensive elements of the network system.

### BRIEF DESCRIPTION OF THE DRAWINGS

FIG. 1 is a schematic flow diagram of a method for collecting and processing offensive and defensive elements based on multi-source data in a preferred embodiment of the embodiment of the disclosure.

### DETAILED DESCRIPTION OF THE EMBODIMENTS

In the following, the specific embodiments of the disclosure will be further described in detail with the attached drawings and embodiments. The following embodiments are used to illustrate this disclosure, but are not used to limit the scope of this disclosure.

In the description of the disclosure, it should be understood that the azimuth or positional relationship indicated by the terms “center”, “up”, “down”, “front”, “back”, “left”, “right”, “vertical”, “horizontal”, “top”, “bottom”, “inside” and “outside”. and so on is based on the azimuth or positional relationship shown in the attached drawings, only for the convenience of describing the disclosure and simplifying the description, and may not indicate or imply that the devices or elements referred to must have a specific orientation, be constructed and operated in a specific orientation, and therefore may not be understood as limitations of this disclosure.

The terms “first” and “second” are only used for descriptive purposes, and may not be understood as indicating or implying relative importance or implicitly indicating the number of indicated technical features. Therefore, the features defined as “first” and “second” may include one or more of these features explicitly or implicitly. In the description of this disclosure, unless otherwise specified, “multiple” means two or more.

In the description of this disclosure, it should be noted that unless otherwise specified and limited, the terms “installation”, “connecting” and “connection” should be broadly understood, for example, fixed connection may be used, detachable connection or integrated connection may be used. A mechanical connection or an electrical connection may be also used. A direct connection, an indirect connection through an intermediate medium may be also used, and a connection inside two elements may be also used. For those skilled in the art, the specific meanings of the above terms in this disclosure may be understood in specific circumstances.

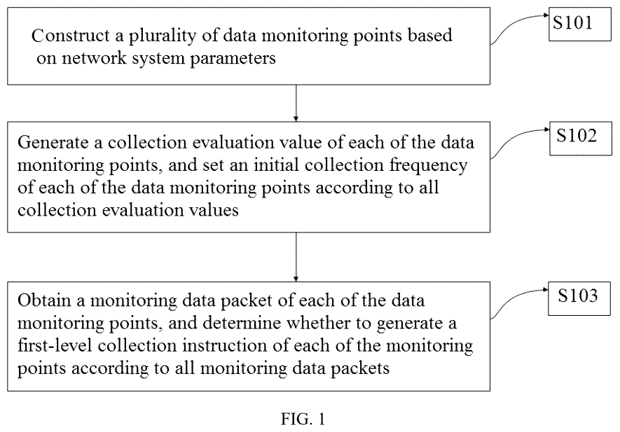

As shown in FIG. 1, a method for collecting and processing offensive and defensive elements based on multi-source data in a preferred embodiment of the disclosure includes:

S101: multiple data monitoring points are constructed based on network system parameters;

S102: a collection evaluation value of each of the data monitoring points is generated, and an initial collection frequency of each of the data monitoring points is set according to all collection evaluation values; and

S103: a monitoring data packet of each of the data monitoring points is obtained, and whether to generate a first-level collection instruction of each of the monitoring points is determined according to all monitoring data packets;
where constructing multiple data monitoring points includes:
a data monitoring point sequence A is built, and A=(a₁, a₂ . . . aᵢ . . . aₙ), where aᵢ is an i-th data monitoring point; n is a number of the data monitoring points.

Specifically, multiple data monitoring points are set according to the types of offensive and defensive elements combined with the network system structure, and a single data monitoring point represents a node that collects offensive and defensive elements, including but not limited to terminal nodes, network nodes, cloud nodes, IoT nodes, application nodes and the like in the network system.

Specifically, generating a collection evaluation value of each of the data monitoring points includes:
aᵢ is sequentially set as a monitoring point to be evaluated according to the data monitoring point sequence A;
a correlated value between the monitoring point to be evaluated and each of the data monitoring points is generated based on a preset correlation model;
a correlated monitoring point sequence P of the monitoring point to be evaluated is built based on all correlated values, and P=(p₁, p₂ . . . pᵢ . . . pₙ₁), where n₁ is a number of correlated monitoring points of the monitoring point to be evaluated; pᵢ is an i-th correlated monitoring point of the monitoring point to be evaluated;
a historical data packet of the monitoring point to be evaluated is obtained;
a collection evaluation value b of the monitoring point to be evaluated is generated according to the correlated monitoring point sequence P and the historical data packet;
the collection evaluation value of each of the data monitoring points is sequentially generated; and
a collection evaluation value sequence B is built, and B=(b₁, b₂ . . . bᵢ . . . bₙ), where bᵢ is a collection evaluation value of an i-th data monitoring point.

Specifically, the corresponding correlated value is generated according to the correlation between the monitoring point to be evaluated and the data in each of the data monitoring points.

Specifically, according to the data interaction amount between the monitoring point to be evaluated and each of the data monitoring points, the corresponding correlated value is generated based on the correlation between the offensive and defensive elements to be collected by the monitoring point to be evaluated and each data monitoring point. For example, if the monitoring point to be evaluated is an offensive element, the correlated value between the data monitoring point and the monitoring point to be evaluated is large if the analysis is required according to the state of the defensive elements of a single data monitoring point when the offensive element changes, the specific value rules of correlated value may be set according to the actual historical monitoring parameters of the network system.

Specifically, the correlated value threshold is set according to historical parameters. If the correlated value of a single data monitoring point is greater than the correlated value threshold, the data monitoring point is set as the correlated monitoring point of the monitoring point to be evaluated. When the state of the offensive and defensive elements of the monitoring point to be evaluated fluctuates, the greater the possibility that the state of the offensive and defensive elements of the correlated monitoring point fluctuates. Relevant offensive and defensive element data of correlated monitoring points should be collected in time for risk analysis.

Specifically, generating a collection evaluation value b of the monitoring point to be evaluated includes:

$$b = e 1 * Q 1 * [ {\sum }_{i = 1}^{θ1} {β}_{i} * {v}_{i} ] + e 2 * θ 2 * [ {\sum }_{i = 1}^{n 1} {η}_{i} * {s}_{i} ] ;$$

where, e1 is a preset first weight coefficient; e2 is a preset second weight coefficient; Q1 is a preset first fixed coefficient; Q2 is a preset second fixed coefficient; θ1 is a number of historical evaluation indicators; βᵢ is an influence factor of an i-th historical evaluation indicator; vᵢ is a reference value of the i-th historical evaluation indicator generated based on the historical data packet; n1 is a number of correlated monitoring points of the monitoring point to be evaluated; ηᵢ is an influence factor of an i-th correlated monitoring point of the monitoring point to be evaluated; sᵢ is an auxiliary evaluation value of the i-th correlated monitoring point of the monitoring point to be evaluated.

Specifically, historical evaluation indicators include, but are not limited to, the probability of fluctuation of offensive and defensive elements of the monitoring point to be evaluated, the probability of fresh data, the historical false alarm rate of the monitoring point to be evaluated, credit rating and other parameters. Through the quantitative processing of each historical evaluation indicator, the accurate analysis of the monitoring points to be evaluated is realized.

Specifically, the greater the collection evaluation value, the greater the possibility of state fluctuation of the offensive and defensive elements corresponding to the monitoring points to be evaluated.

Specifically, the influence factor of each correlated monitoring point may be set according to correlated value, and the greater the correlated value, the greater the corresponding influence factor.

Specifically, the influence factors of each historical evaluation indicator may be set according to historical parameters.

Specifically, the auxiliary evaluation value of the correlated monitoring point is the weighted value of the real-time reference value of all historical evaluation indicators of the correlated monitoring point. That is, the

$$[ {\sum }_{i = 1}^{θ 1} {β}_{i} * {v}_{i} ]$$

part of the correlated monitoring point.

Specifically, all parameters in the model are normalized by presetting the first fixed coefficient and the second fixed coefficient, so that all parameters in the model are in the same value range.

It may be understood that in the above embodiment, multiple data monitoring points are built in the network system according to the characteristics of offensive and defensive elements, and the preprocessing model and initial collection frequency of each data monitoring point are dynamically adjusted according to the historical characteristics of each of the data monitoring points, thus reducing the overall operating load, improving the efficiency of collecting and analyzing the offensive and defensive elements of the network system.

In a preferred embodiment of the embodiments of the disclosure, obtaining a monitoring data packet of each of the data monitoring points includes:
aᵢ is sequentially set as a target monitoring point according to the data monitoring point sequence A;
a collection time axis of the target monitoring point is built according to an initial collection frequency of the target monitoring point, where the collection time axis includes multiple collection time nodes;
a preprocessing model of the target monitoring point is built;
original data of the target monitoring point at a current collection time node is obtained;
a current monitoring data packet of the target monitoring point is generated according to the preprocessing model and the original data;
an abnormal risk value c of the target monitoring point is generated according to the monitoring data packet;
whether to generate a first-level collection instruction of the target monitoring point is determined according to the abnormal risk value c; and
whether each of the data monitoring points generates the first-level collection instruction is sequentially determined.

Specifically, the greater the abnormal risk value c, the faster the corresponding initial collection frequency, that is, the shorter the time interval between adjacent collection time nodes of the target monitoring point.

Specifically, by dynamically adjusting the initial collection frequency of target monitoring points, the abnormal fluctuation of offensive and defensive elements in target monitoring points may be warned in time, and the overall data collection load and false alarm rate may be reduced.

Specifically, generating an abnormal risk value c of the target monitoring point includes:
an initial abnormal value d1 of the target monitoring point is generated based on the monitoring data packet;

$$d 1 = [ {\sum }_{i = 1}^{θ 2} {μ}_{i} * {j}_{i} ] ;$$

where, θ2 is a number of characteristic indicators of the target monitoring point; μᵢ is an influence factor of an i-th characteristic indicator; jᵢ is a matching value of the i-th characteristic indicator generated based on the monitoring data packet;
an initial abnormal value threshold D is preset;
if d1>D, the abnormal risk value c of the target monitoring point is set as the initial abnormal value d1, that is, c=d1;
if d1<D, a second-level abnormal value d2 is generated; and
the abnormal risk value c is generated according to the initial abnormal value d1 and the second-level abnormal value d2, where c=e3*d1+e4*d2;
where e3 is a preset third weight coefficient; e4 is a preset fourth weight coefficient.

Specifically, generating a second-level abnormal value d2 includes:

$$d 2 = [ {\sum }_{i = 1}^{θ 3} {λ}_{i} * {( {w}_{i} - {w}_{i}^{′} )}^{2} ] ;$$

where, θ3 is a number of abnormal indicators of the target monitoring point; λᵢ is an influence factor of an i-th abnormal indicator of the target monitoring point; wᵢ is a real-time reference value of the i-th abnormal indicator of the target monitoring point; w′ᵢ is a standard reference value of the i-th abnormal indicator of the target monitoring point.

Specifically, according to the types of offensive and defensive elements that the target monitoring point needs to collect, the corresponding characteristic indicator are set. The types of offensive and defensive elements include but are not limited to: firewall parameters, IDS/IPS parameters, file integrity monitoring parameters, network probe parameters, malicious app, system vulnerability parameters, protocol vulnerability parameters, malicious processes, sensitive files, file-free attack parameters, configuration vulnerabilities, vulnerability utilization packages, etc.

Specifically, the corresponding characteristic indicator are set according to the types of offensive and defensive elements to be monitored by the target monitoring point. For example, when exploiting the vulnerability utilization packages, multiple groups of Shellcode characteristic byte sequences may be set. By analyzing the matching degree of real-time characteristic indicator, whether the offensive and defensive elements of the target monitoring point fluctuate is determined.

Specifically, the specific values of the third weight coefficient and the fourth weight coefficient may be set according to historical parameters, and e3+e4=1.

Specifically, the abnormal indicators are set according to the types of offensive and defensive elements that need to be collected at the target monitoring point, such as setting data flow fluctuation, data entropy value and other parameters as abnormal indicators at the nodes that need to collect offensive elements, timely warning the potential attack risks that may be generated at the target monitoring point, and timely collecting relevant attack elements for analysis.

Specifically, the influence factor of each abnormal value may be set according to historical parameters.

It may be understood that in the above embodiment, by building a multi-level early warning strategy for each data monitoring point, the fluctuation state of offensive and defensive elements at each data monitoring point may be warned in time, and the collection efficiency of offensive and defensive elements may be improved.

In a preferred embodiment of the embodiments of the disclosure, determining whether to generate the first-level collection instruction of the target monitoring point according to the abnormal risk value c includes:
an abnormal risk value threshold C1 is pre-processed;
if c<C1, the target monitoring point fails to generate the first-level collection instruction; and
if c>C1, the target monitoring point generates the first-level collection instruction.

Specifically, the first-level collection instruction includes:
a first-level collection strategy of the target monitoring point is set according to the abnormal risk value c, and a first-level feedback data packet of the target monitoring point is obtained according to the first-level collection strategy;
a correlated monitoring point sequence A2 of the target monitoring point is built, and A2=(a₂₁, a₂₂ . . . a₂ᵢ . . . a₂ₙ₂), where a₂ᵢ is a number of i-th correlated monitoring points of the target monitoring point; n2 is a number of correlated monitoring points of the target monitoring point;
an auxiliary collection strategy of each of the correlated monitoring points is set;
a second-level feedback data packet of each of the correlated monitoring points is obtained according to all auxiliary collection strategies;
whether to generate an early warning instruction of each of the correlated monitoring points is determined according to the second-level feedback data packet; and
a data packet to be analyzed at the target monitoring point is generated according to the first-level feedback data packet and all second-level feedback data packets.

Specifically, the greater the abnormal risk value, the greater the fluctuation of the offensive and defensive elements of the target monitoring point, which needs to be analyzed in time.

Specifically, the feedback data packet is the real-time data parameter of each data monitoring point. The first-level feedback data packet and each second-level feedback data packet are fused to generate the data packet to be analyzed, and the data packet to be analyzed is stored in the sub-repository corresponding to the target monitoring point, so as to realize the collaborative collection of multi-dimensional heterogeneous data and improve the efficiency of collecting and analyzing the offensive and defensive elements of the network system.

Specifically, the first-level collection strategy refers to setting the continuous collection duration of the target monitoring point according to the abnormal risk value of the target monitoring point. The greater the abnormal risk value, the longer the corresponding continuous collection duration.

Specifically, the second-level collection strategy refers to setting the corresponding collection duration according to the correlated value between the correlated monitoring point and the target monitoring point, and analyzing the abnormal risk value of the correlated monitoring point according to the collected second-level feedback data packet. If the abnormal risk value exceeds the abnormal risk value threshold, the first-level collection instruction of the correlated monitoring point is generated, and the corresponding analysis data packet is obtained.

It may be understood that in the above-mentioned embodiments, at the same time, by constructing a correlation model, the collection strategy of the correlated monitoring points is adjusted in time when data is collected at the target monitoring points, so as to realize collaborative collection of multi-dimensional heterogeneous data and improve the efficiency of collection and analysis of offensive and defensive elements of the network system.

Based on another preferred embodiment of the method for collecting and processing offensive and defensive elements based on multi-source data in any of the above preferred embodiments, this preferred embodiment provides a system for collecting and processing offensive and defensive elements based on multi-source data, including:
a central control module, configured for constructing multiple data monitoring points based on network system parameters;
a first processing module, configured for generating a collection evaluation value of each of the data monitoring points;
a second processing module, configured for setting an initial collection frequency of each of the data monitoring points according to all collection evaluation values; and
a third processing module, configured for obtaining a monitoring data packet of each of the data monitoring points and determining whether to generate a first-level collection instruction of each of the monitoring points according to all monitoring data packets;
where the central control module is further configured for building a data monitoring point sequence A, and A=(a₁, a₂ . . . aᵢ . . . aₙ), where aᵢ is an i-th data monitoring point; n is a number of the data monitoring points.

Specifically, the first processing module is further configured for:
sequentially setting aᵢ as a monitoring point to be evaluated according to the data monitoring point sequence A;
generating a correlated value between the monitoring point to be evaluated and each of the data monitoring points based on a preset correlation model;
building a correlated monitoring point sequence P of the monitoring point to be evaluated based on all correlated values, and P=(p₁, p₂ . . . pᵢ . . . pₙ₁), where n1 is a number of correlated monitoring points of the monitoring point to be evaluated; pᵢ is an i-th correlated monitoring point of the monitoring point to be evaluated;
obtaining a historical data packet of the monitoring point to be evaluated;
generating a collection evaluation value b of the monitoring point to be evaluated according to the correlated monitoring point sequence P and the historical data packet;
sequentially generating the collection evaluation value of each of the data monitoring points; and
building a collection evaluation value sequence B, and B=(b₁, b₂ . . . bᵢ . . . bₙ), where bᵢ is a collection evaluation value of an i-th data monitoring point.

According to the first concept of the disclosure, multiple data monitoring points are established in the network system according to the characteristics of offensive and defensive elements, and the preprocessing model and initial collection frequency of each data monitoring point are dynamically adjusted according to the historical characteristics of each data monitoring point, thereby reducing the overall operating load. The efficiency of collecting and analyzing the offensive and defensive elements of the network system is improved.

According to the second concept of the disclosure, by building a multi-level early warning strategy for each of the data monitoring points, the fluctuation state of the offensive and defensive elements of each data monitoring point is warned in time, and the collection efficiency of the offensive and defensive elements is improved. At the same time, by constructing a collection model, the collection strategy of the correlated monitoring point is adjusted in time when the target monitoring point collects data, so as to realize the collaborative collection of multi-dimensional heterogeneous data and improve the collection and analysis efficiency of the offensive and defensive elements of the network system.

What has been described above is only the preferred embodiment of this disclosure. It should be pointed out that some improvements and substitutions may be made by ordinary skilled in this technical field without departing from the technical principles of this disclosure, and these improvements and substitutions should also be regarded as the protection scope of this disclosure.

What is claimed is:

1. A method for collecting and processing offensive and defensive elements based on multi-source data, comprising:
constructing a plurality of data monitoring points based on network system parameters;
generating a collection evaluation value of each of the data monitoring points, and setting an initial collection frequency of each of the data monitoring points according to all collection evaluation values; and
obtaining a monitoring data packet of each of the data monitoring points, and determining whether to generate a first-level collection instruction of each of the monitoring points according to all monitoring data packets;
wherein constructing a plurality of data monitoring points comprises:
building a data monitoring point sequence A, and A=(a₁, a₂ . . . aᵢ . . . aₙ), wherein aᵢ is an i-th data monitoring point; n is a number of the data monitoring points.

2. The method for collecting and processing offensive and defensive elements based on multi-source data according to claim 1, wherein generating a collection evaluation value of each of the data monitoring points comprises:
sequentially setting aᵢ as a monitoring point to be evaluated according to the data monitoring point sequence A;
generating a correlated value between the monitoring point to be evaluated and each of the data monitoring points based on a preset correlation model;
building a correlated monitoring point sequence P of the monitoring point to be evaluated based on all correlated values, and P=(p₁, p₂ . . . pᵢ . . . pₙ₁), wherein n₁ is a number of correlated monitoring points of the monitoring point to be evaluated; pᵢ is an i-th correlated monitoring point of the monitoring point to be evaluated;
obtaining a historical data packet of the monitoring point to be evaluated;
generating a collection evaluation value b of the monitoring point to be evaluated according to the correlated monitoring point sequence P and the historical data packet;
sequentially generating the collection evaluation value of each of the data monitoring points; and
building a collection evaluation value sequence B, and B=(b₁, b₂ . . . bᵢ . . . bₙ), wherein bᵢ is a collection evaluation value of an i-th data monitoring point.

3. The method for collecting and processing offensive and defensive elements based on multi-source data according to claim 2, wherein generating a collection evaluation value b of the monitoring point to be evaluated comprises:
$$b = e 1 * Q 1 * [ {\sum }_{i = 1}^{θ 1} {β}_{i} * {v}_{i} ] + e 2 * θ 2 * [ {\sum }_{i = 1}^{n 1} {η}_{i} * {s}_{i} ] ;$$
wherein, e1 is a preset first weight coefficient; e2 is a preset second weight coefficient; Q1 is a preset first fixed coefficient; Q2 is a preset second fixed coefficient; θ1 is a number of historical evaluation indicators; βᵢ is an influence factor of an i-th historical evaluation indicator; vᵢ is a reference value of the i-th historical evaluation indicator generated based on the historical data packet; n1 is a number of correlated monitoring points of the monitoring point to be evaluated; ηᵢ is an influence factor of an i-th correlated monitoring point of the monitoring point to be evaluated; sᵢ is an auxiliary evaluation value of the i-th correlated monitoring point of the monitoring point to be evaluated.

4. The method for collecting and processing offensive and defensive elements based on multi-source data according to claim 2, wherein obtaining a monitoring data packet of each of the data monitoring points comprises:
sequentially setting aᵢ as a target monitoring point according to the data monitoring point sequence A;
building a collection time axis of the target monitoring point according to an initial collection frequency of the target monitoring point, wherein the collection time axis comprises a plurality of collection time nodes;
building a preprocessing model of the target monitoring point;
obtaining original data of the target monitoring point at a current collection time node;
generating a current monitoring data packet of the target monitoring point according to the preprocessing model and the original data;
generating an abnormal risk value c of the target monitoring point according to the monitoring data packet;
determining whether to generate a first-level collection instruction of the target monitoring point according to the abnormal risk value c; and
sequentially determining whether each of the data monitoring points generates the first-level collection instruction.

5. The method for collecting and processing offensive and defensive elements based on multi-source data according to claim 4, wherein generating an abnormal risk value c of the target monitoring point comprises:
generating an initial abnormal value d1 of the target monitoring point based on the monitoring data packet;
$$d 1 = [ {\sum }_{i = 1}^{θ 2} {μ}_{i} * {j}_{i} ] ;$$
wherein, θ2 is a number of characteristic indicators of the target monitoring point; μᵢ is an influence factor of an i-th characteristic indicator; jᵢ is a matching value of the i-th characteristic indicator generated based on the monitoring data packet;
presetting an initial abnormal value threshold D;
if d1>D, setting the abnormal risk value c of the target monitoring point as the initial abnormal value d1, that is, c=d1;
if d1<D, generating a second-level abnormal value d2; and
generating the abnormal risk value c according to the initial abnormal value d1 and the second-level abnormal value d2, wherein c=e3*d1+e4*d2;
wherein e3 is a preset third weight coefficient; e4 is a preset fourth weight coefficient.

6. The method for collecting and processing offensive and defensive elements based on multi-source data according to claim 5, wherein generating a second-level abnormal value d2 comprises:
$$d 2 = [ {\sum }_{i = 1}^{θ 3} {λ}_{i} * {( {w}_{i} - {w}_{i}^{′} )}^{2} ] ;$$
wherein, θ3 is a number of abnormal indicators of the target monitoring point; λᵢ is an influence factor of an i-th abnormal indicator of the target monitoring point; wᵢ is a real-time reference value of the i-th abnormal indicator of the target monitoring point; w′ᵢ is a standard reference value of the i-th abnormal indicator of the target monitoring point.

7. The method for collecting and processing offensive and defensive elements based on multi-source data according to claim 4, wherein determining whether to generate the first-level collection instruction of the target monitoring point according to the abnormal risk value c comprises:
pre-processing an abnormal risk value threshold C1;
if c<C1, the target monitoring point fails to generate the first-level collection instruction; and
if c>C1, the target monitoring point generates the first-level collection instruction.

8. The method for collecting and processing offensive and defensive elements based on multi-source data according to claim 7, wherein the first-level collection instruction comprises:
setting a first-level collection strategy of the target monitoring point according to the abnormal risk value c, and obtaining a first-level feedback data packet of the target monitoring point according to the first-level collection strategy;
building a correlated monitoring point sequence A2 of the target monitoring point, and A2=(a₂₁, a₂₂ . . . a₂ᵢ . . . a₂ₙ₂), wherein a₂ᵢ is a number of i-th correlated monitoring points of the target monitoring point; n2 is a number of correlated monitoring points of the target monitoring point;
setting an auxiliary collection strategy of each of the correlated monitoring points;
obtaining a second-level feedback data packet of each of the correlated monitoring points according to all auxiliary collection strategies;
determining whether to generate an early warning instruction of each of the correlated monitoring points according to the second-level feedback data packet; and
generating a data packet to be analyzed at the target monitoring point according to the first-level feedback data packet and all second-level feedback data packets.

9. A system for collecting and processing offensive and defensive elements based on multi-source data, using the method for collecting and processing offensive and defensive elements based on multi-source data according to claim 1, comprising:
a central control module, configured for constructing a plurality of data monitoring points based on network system parameters;
a first processing module, configured for generating a collection evaluation value of each of the data monitoring points;
a second processing module, configured for setting an initial collection frequency of each of the data monitoring points according to all collection evaluation values; and
a third processing module, configured for obtaining a monitoring data packet of each of the data monitoring points and determining whether to generate a first-level collection instruction of each of the monitoring points according to all monitoring data packets;
wherein the central control module is further configured for building a data monitoring point sequence A, and A=(a₁, a₂ . . . aᵢ . . . aₙ), wherein aᵢ is an i-th data monitoring point; n is a number of the data monitoring points.

10. The system for collecting and processing offensive and defensive elements based on multi-source data according to claim 9, wherein the first processing module is further configured for:
sequentially setting aᵢ as a monitoring point to be evaluated according to the data monitoring point sequence A;
generating a correlated value between the monitoring point to be evaluated and each of the data monitoring points based on a preset correlation model;
building a correlated monitoring point sequence P of the monitoring point to be evaluated based on all correlated values, and P=(p₁, p₂ . . . pᵢ . . . pₙ₁), wherein n1 is a number of correlated monitoring points of the monitoring point to be evaluated; pᵢ is an i-th correlated monitoring point of the monitoring point to be evaluated;
obtaining a historical data packet of the monitoring point to be evaluated;
generating a collection evaluation value b of the monitoring point to be evaluated according to the correlated monitoring point sequence P and the historical data packet;
sequentially generating the collection evaluation value of each of the data monitoring points; and
building a collection evaluation value sequence B, and B=(b₁, b₂ . . . bᵢ . . . bₙ), wherein bᵢ is a collection evaluation value of an i-th data monitoring point.
